(19) United States
(12) Patent Application Publication
(10) Pub. No.: US 2005/0086611 A1
(43) Pub. Date: Apr. 21, 2005

(54) Display method and display device

(76) Inventors: Masaaki Takabe, Tokyo (JP); Tsunayuki Ohwa, Tokyo (JP); Motoyoshi Shiine, Tokyo (JP)

Correspondence Address: William S. Frommer, Esq.;FROMMER LAWRENCE & HAUG LLP, 745 Fifth Avenue, New York, NY, 10151, US

(21) Appl. No.: 10/827,399

(22) Filed: Apr. 19, 2004

(30) Foreign Application Priority Data
Apr. 21, 2003 (JP) 2003-116149

(51) Int. Cl. G06F 3/00

(52) U.S. Cl. 715/823; 715/810; 715/817; 715/818; 715/819; 715/820; 715/829; 715/830; 715/860

(57) ABSTRACT

A display mode in which a hierarchical structure or the like in a menu screen is easily understood is provided in electronic equipment that displays the menu screen. When an input state of electronic equipment is displayed on the menu screen, a ring is displayed on a picture screen; a plurality of icons are displayed at predetermined intervals on the ring; if there is an operation of selecting an item in the menu screen, each of the icons displayed on the ring is rotated with maintaining the order of arrangement; and if there is an operation of confirming a selected item in the menu screen, an input with respect to an icon displayed at a specific position of the ring is performed.

### BACKGROUND OF THE INVENTION

1. Field of the Invention:

This invention relates to a display method and a display device suitable for use in portable electronic equipment provided with a display means to display a menu screen, such as a video camera, for example.

2. Description of the Related Art:

There has been widely known electronic equipment with a display panel, in which a menu screen is displayed and various settings are performed by key operation in accordance with the display on the menu screen. For example, a video camera which mainly takes a moving picture and a digital camera which mainly takes a still picture are each equipped with a liquid crystal display panel as a viewfinder. Further, a mobile phone unit is also equipped with a liquid crystal display panel to display telephone numbers of senders and receivers and to display received mails and data.

Among those apparatuses, there is known an apparatus in which a menu screen displaying items that can be operated, lists of present operation mode, and the like are displayed on the liquid crystal display panel by performing a predetermined operation; and selection of function and change of mode can be made by the key operation that selects a specific item in that menu screen.

Patent document 1 discloses an example in which a menu screen is displayed by means of a plurality of icons by figures displayed on a display panel provided with electronic equipment such as a mobile phone unit. When equipment is configured to display such menu screen to be operated, the user could reach comparatively easily to a screen in which an aimed operation can be made, even if the equipment has many functions, and the operability can be improved. Particularly, it is suitable for use in small-sized portable equipment having a limited number of keys arranged on the equipment.

Patent document 1: Japanese Laid-Open Patent Application No. 2002-175140

In the meantime, recently electronic equipment such as a video camera or a mobile phone unit tends to have multiple functions and accordingly the number of functions to be selected on the menu screen also tends to increase. Therefore, although a menu screen is displayed, it becomes difficult to display all the functions which can be selected, at one time.

In order to solve the above problem, there is known such equipment having, for example, a construction in which multiple functions are set using a plurality of menu screen such that a menu screen is displayed with a hierarchical structure; and at first, a classification desired to select is chosen by a menu screen of a top layer, and next, a detailed menu screen about that chosen classification is made to display. However, when a menu screen of a hierarchical structure as described above is adopted, for example, at first it is not easily understood which item is to display a menu screen about an aimed operation in the state in which a menu screen of a top layer is displayed. Particularly, it is not understood which item of a menu screen has a lower layer while a menu screen of a top layer is displayed, so that it is not necessarily a convenient display form for the user.

It should be noted that the problem of displaying a menu screen on a picture screen of a video camera and a mobile phone unit is mentioned above; however, there is a similar problem in any apparatus as well, if it is electronic equipment displaying a similar menu screen.

An object of the present invention is to provide a display form with which a hierarchical structure and the like of a menu screen can be easily understood from a display in electronic equipment displaying the menu screen.

### SUMMARY OF THE INVENTION

The present invention is that, when an input state of electronic equipment is displayed using a menu screen, a ring is displayed on a picture screen and a plurality of icons are displayed at predetermined intervals on the ring; when an operation of selecting an item on the menu screen is performed, each of icons displayed on the ring is rotated on the ring with maintaining the order of arrangement; and when there is an operation that confirms a selected item on the menu screen, an input operation related to an icon that is displayed at a specific position of the ring can be performed.

Accordingly, a plurality of icons can be displayed along a ring, so that a selection of a desired icon on a menu screen can be easily performed.

### BRIEF DESCRIPTION OF DRAWINGS

FIG. 1 is a block diagram showing an example of configuration of a video camera according to an embodiment of the present invention;

FIG. 2 is a flow chart showing an example of processing at the time when a menu screen is displayed according to an embodiment of the present invention;

FIG. 3 is a schematic explanatory view showing an example of display condition (when a ring is displayed) according to an embodiment of the present invention;

FIG. 4 is a schematic explanatory view showing an example of display state (when an operational screen of the bottom layer is displayed) according to an embodiment of the present invention;

FIG. 5 is an explanatory view showing an example of display according to an embodiment of the present invention;

FIG. 6 is an explanatory view showing an example of display according to an embodiment of the present invention;

FIG. 7 is an explanatory view showing an example of display according to an embodiment of the present invention;

FIG. 8 is an explanatory view showing an example of display according to an embodiment of the present invention;

FIG. 9 is an explanatory view showing an example of display according to an embodiment of the present invention; and

FIG. 10 is an explanatory view showing an example of display according to an embodiment of the present invention.

### BEST MODE FOR CARRYING OUT THE INVENTION

Hereinafter, an embodiment of the present invention will be explained with reference to attached drawings.

In this embodiment, the present invention is applied to electronic equipment called a video camera in which a moving picture is mainly picked up and the obtained image data is stored in a recording medium such as a magnetic tape or an optical disc, or in a memory medium such as a memory card or the like. In addition, not only a moving picture, but also a still picture of high resolution taken at a predetermined timing can be recorded (stored) in media such as a memory card.

A video camera of this embodiment has a configuration in which a picked-up image is displayed on a display means consisting of a liquid crystal display panel or the like, and further a picture can be taken while confirming the image that is displayed on the display panel.

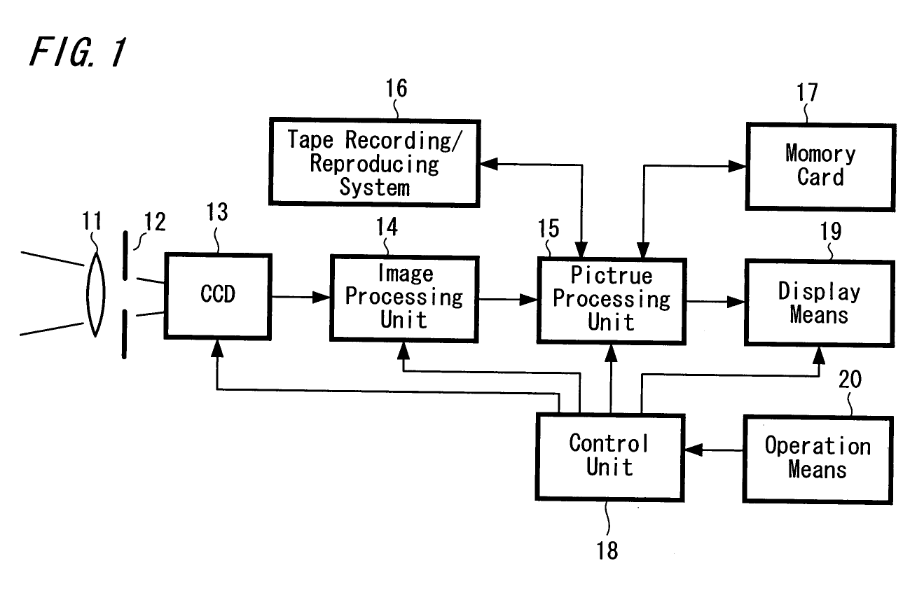

FIG. 1 is a diagram showing an example of the whole configuration of the video camera. An optical image that is focused on the sensor surface of an image sensor 13 such as a CCD image sensor through the optical system such as a lens 11 is read out as an electric signal to be supplied to an image processing unit 14. In this case, an iris mechanism 12 is arranged in the light pass where the lens 11 and others are arranged.

In the image processing unit 14, image processing of making the image signal read out from the image sensor 13 into the picture signal (video signal) of a predetermined format is performed, and the picture signal output from the image processing unit 14 is supplied to a picture processing unit 15, and various kinds of picture processing are performed. Later described image processing in which various characters, numerals, and figures are superimposed on the picture signal for display is also carried out in the picture processing unit 15. Further, the picture processing unit 15 can also perform necessary arithmetic processing, in case that, when those characters, numerals, and figures are superimposed, a size and others of characters and figures to be displayed are required to be changed in order to perform a display as later mentioned.

The picture signal for display that is processed in the picture processing unit 15 is supplied to a display means 19 to be displayed on a display panel provided with the display means as a picked-up image. As the display panel, for example, a liquid crystal display panel is used. Further, a tape recording and reproducing system 16 is connected to the picture processing unit 15, and the picked-up picture signal is recorded on magnetic tape. Note that though an audio processing system is not shown in FIG. 1, audio data obtained concurrently with taking pictures are also recorded on the magnetic tape.

Furthermore, a memory card 17 loaded into a video camera body is connected to the picture processing unit 15, and can store still picture signals taken at a predetermined timing, moving picture signals compressed and encoded by a predetermined coding method and the like.

A control unit 18 controls: image pick-up in the image sensor 13, signal processing in the image processing unit 14 and picture processing unit 15, display processing in the display means 19, and recording (storing) processing of a picture signal into the tape recording and reproducing system 16 and memory card 17. An operation means 20 composed of operation keys and dials and the like is connected to the control unit 18, and the control unit 18 performs control over the image pick-up operation based on the operation of the operation means 20. Further, settings of various modes and the like relating to pick-up of pictures can also be made by the control of the control unit 18 based on the operation of the operation means 20. When modes and the like are set up, a menu screen is displayed in the display means 19.

Character data, such as characters, numerals, figures, and others necessary to display a menu screen, are provided in advance in the picture processing unit 15, for example. In this case, if it is necessary to display transformed characters, numerals, and figures in accordance with a display form of a menu screen, the provided character data regarding characters, numerals, figures, and others are transformed by arithmetic processing in the picture processing unit 15 (or using a control unit 18) to obtain a required display form. The display mode of a menu screen in this embodiment will be described later in detail; a plurality of rings having a hierarchical structure are displayed on a picture screen, and icons each corresponding to menu items are displayed in that ring.

As the operation means 20, not only keys composed of simple push buttons arranged in a body of video camera but also operation means of various shapes, such as input means called a Jog dial capable of being operated by a rotation (and a push) can be applied. Also, for example, a so-called touch panel can be applied as operation means 20, in which input is made by touching the surface of a display panel provided with a display means 19. In case of using that touch panel, other operation means such as keys and the like can be used together. It should be noted that whichever construction is used in this embodiment, an operation unit that is used as an up-key and an operation unit that is used as a down-key are provided as the operation means 20. Also, instead of providing two physical keys of the up-key and down-key, such operation unit of a Jog dial that functions as an up-key and a down-key by the rotation operation in one direction and the rotation operation in the other direction can also be used.

When a menu screen is displayed, picture processing of superimposing a menu screen upon the picked-up image signal obtained for display is performed in the picture processing unit 15 based on an operation of the control unit 18. Alternatively, the picked-up image may not be displayed on the display means 19, and only a menu screen is displayed.

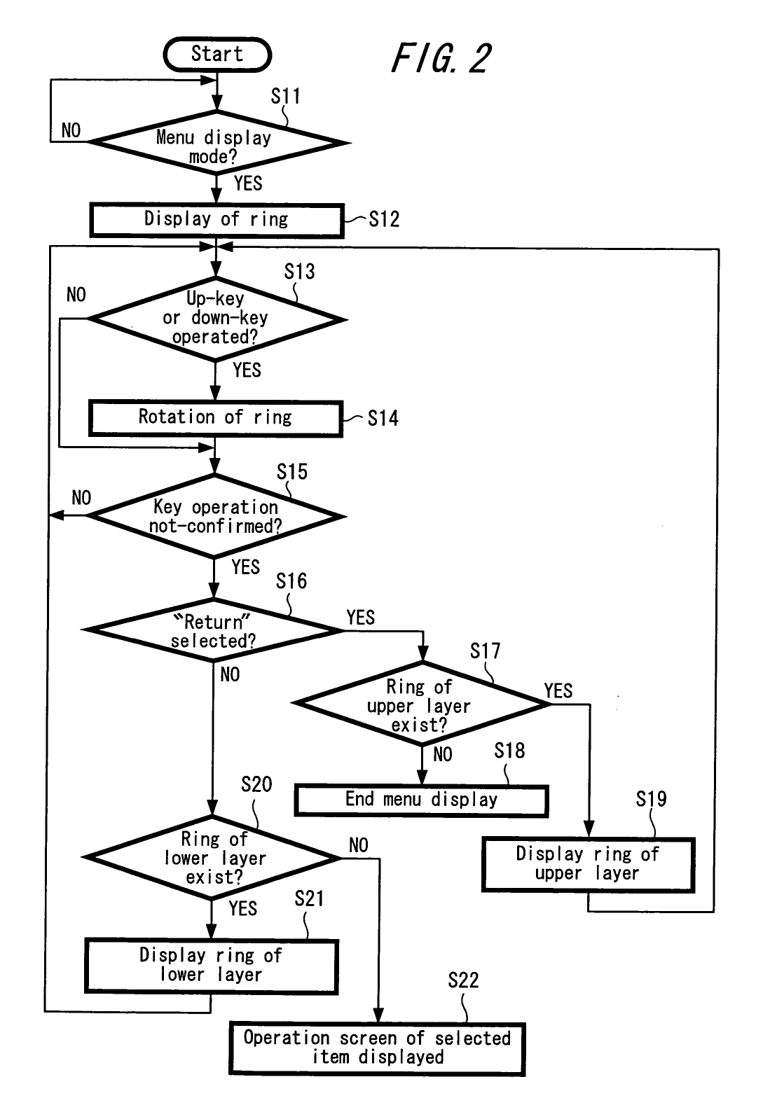

Next, a display processing of a menu screen in the display panel provided with the display means 19 in the video camera of this embodiment is explained with reference to a flow chart of FIG. 2. When the control unit 18 judged that it was instructed to display a menu screen by the operation of a predetermined key constituting the operation means 20 and so on, the display processing of a menu screen is started (Step S11).

When an instruction for displaying a menu screen is judged, the control unit 18 sends an order to the picture processing unit 15, and the display processing of a menu screen is carried out. Hereupon, at first, a ring of the oval shape is displayed as a menu display of the top layer, and a plurality of icons are displayed in predetermined order at approximately regular intervals on the ring (Step S12). Each icon is made to describe classified items to be operated, and a figure and a name thereof are displayed. Although a specific display example will be described later, icons that are arranged on one ring are made to be plural, here five or so, and one icon thereof is displayed in the center of the most front side of the ring of an oval shape. The icon displayed in the center of the most front side is, for example, displayed slightly larger than the other icons. This icon displayed in the center is an icon that is selected when a confirming operation is performed. Also, one of the plurality of icons is provided to instruct returning to the previous display state by one step.

In this state, it is judged whether or not there is an operation of up-key or down-key that is provided as an operation means 20 (Step 13). Hereupon, when it is judged that there is an operation of up-key or down-key, with maintaining a display order of icons, the position of displayed icon is rotated along a display position of the ring only by the amount equivalent to that of operation (Step 14).

Under that condition, it is judged whether or not there is an operation of key that confirms selection of a menu screen (Step 15), and if there is no operation of key confirming the selection, processing goes back to Step 13. When there is an operation of key that confirms the selection, it is judged whether or not an icon displayed in the front at that time is an icon indicating the return, (Step S16).

Then, if the icon in the front is an icon indicating the return, it is judged whether or not there is a ring of upper layer than the ring displayed at present (Step S17); if there is a ring of upper layer, display on a picture screen is switched over to the display of the whole ring of upper layer (Step S19); and processing after the step S13 is performed with respect to icons displayed with a ring of that layer. When it is judged that there is no ring of upper layer at Step 17, a display of a menu screen is made to finish (Step S18).

Further, if a selected icon is not the icon indicating the return at the judgment of Step 16, it is judged whether or not there is a ring of lower layer related to that icon (Step 20); and if there is no ring of lower layer, an operation screen of items relating to the icon selected at that time is displayed (Step S22). Further, if there is a ring of lower layer at Step S20, the display on a picture screen is switched over to that of the whole ring of lower layer (Step S21) and processing after the step S13 is performed with respect to icons displayed with a ring of that layer.

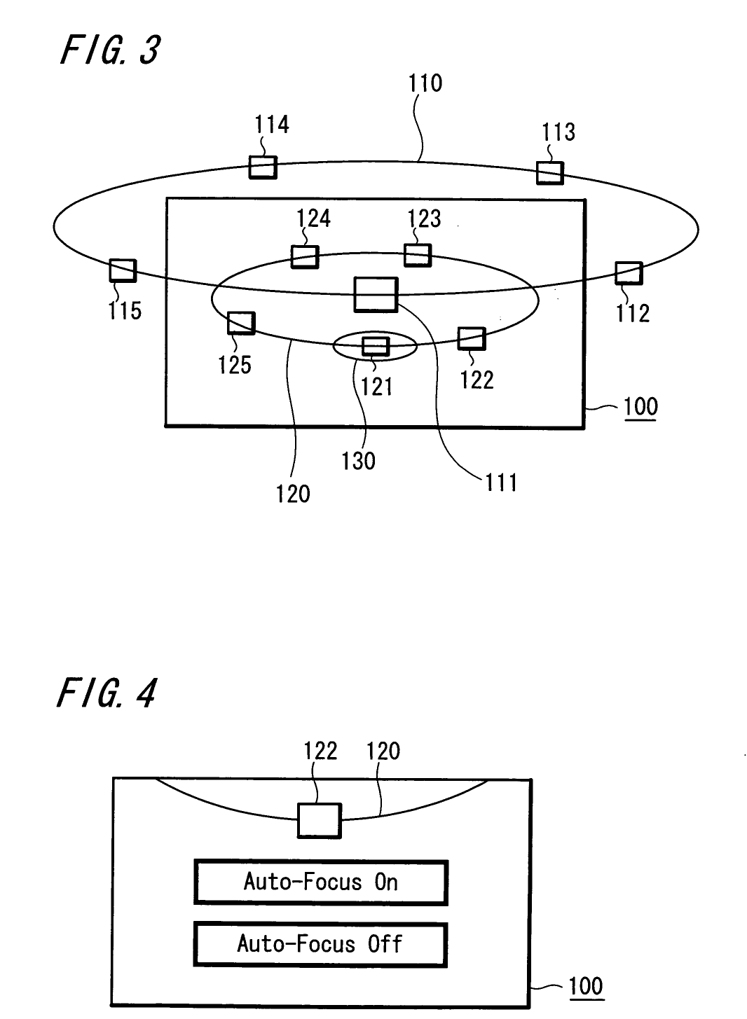

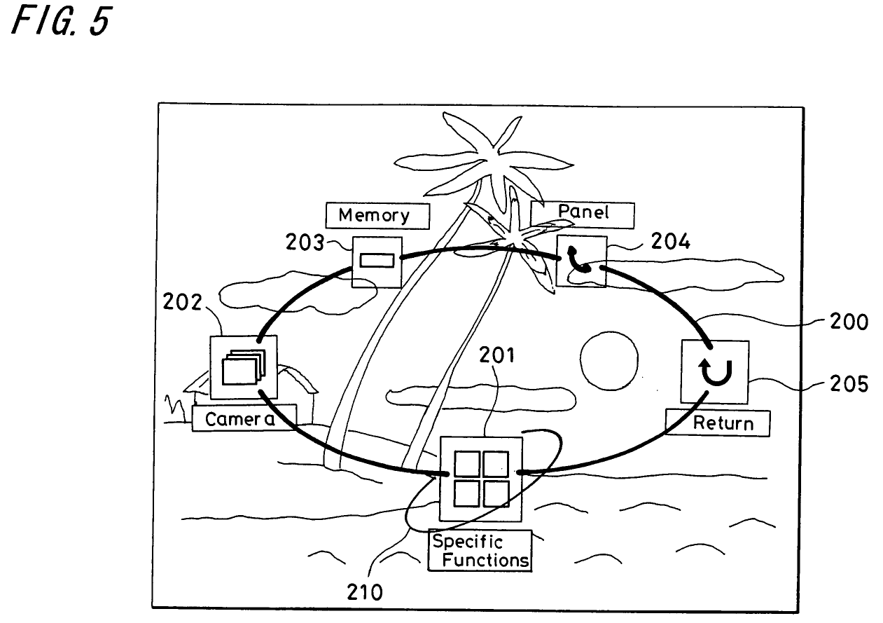

Next, a practical display condition is schematically explained with reference to FIGS. 3 and 4. As shown in FIG. 3, a ring 110 of an upper layer is here provided, and five icons 111, 112, 113, 114, and 115 are arranged on that ring 110; with respect to the icon 111, a ring 120 of lower layer is provided, and five icons 121, 122, 123, 124 and 125 are arranged on the ring 120 of that layer; further with respect to the icon 121, a ring 130 of lower layer is provided as a sub-ring. Note that there may be cases in which a lower ring (sub-ring) is provided with other icons of respective layers; however, to make the explanations simple, those are omitted in FIG. 3.

FIG. 3 shows an example of display, in which the layer of ring 120 that is one layer down from the top layer is selected to be displayed in enlarged scale on a picture screen 100. With respect to the ring 110 of top layer, only the range within a picture screen 100 is displayed. Here, the ring 110 of top layer is enlarged, so that only the icon 111 is within the picture screen 110 and the other icons thereon are outside the display range. Then, if there is a ring of lower layer (ring 130 in FIG. 3) with respect to an icon of the ring 120 being displayed at present, only the ring is displayed regarding the lower layer, and icons on that ring of lower layer are not displayed. Alternatively, only dots or the like may be displayed so that it is understood that actually there are icons on the ring.

Further, the ring of layer being selected at present (ring 120 in FIG. 3) can be displayed with a form different from the rings of other layers. For example, only the ring of layer being selected at present is displayed with a bold line and rings of other layers are displayed with a thin line; or a display color can be different between the ring of layer being selected at present and rings of other layers.

FIG. 4 shows a display example when either icon was selected in the state shown in FIG. 3. For example, there was an operation of selecting the icon 122 on the ring 120 to be confirmed. At that time, only the icon 122 and the ring 120 in the vicinity thereof are displayed on the corner of the upper side of the picture screen 100. Then, a selected screen regarding the items shown as the icon 122 is displayed in the center of the picture screen. Here, if the icon 122 is an icon related to an auto-focus, a display of “auto-focus ON” and a display of “auto-focus OFF” are made, for example; and by the operation of an up-key or a down-key, either display is selected and then confirmed by key operation, so that each operation becomes possible. Further, by the operation of an up-key or a down-key, the icon 122 displayed in the top end is selected and then confirmed by key operation, it is also possible to return to a display in which the ring 120 is displayed on the whole picture screen (namely, the display shown in FIG. 3).

FIGS. 5 through 10 show an example of a display mode in which rings are displayed. In this example, as shown in FIG. 5, a ring 200 of the upper layer is displayed, and five icons are displayed on that ring 200. Here, a menu screen is superimposed over a picture screen taken by a video camera and displayed. Each of the five icons of 201, 202, 203, 204, and 205 shows a function given thereto by a figure and also by the characters of “specific functions”, “camera”, “memory”, “panel”, and “return”. In this example, with respect to the icon 201 indicated as “specific functions” a ring 210 of lower layer is provided, and the ring is displayed around the icon 201 in a smaller diameter. Also, in FIG. 5, the icon 201 is displayed at the center of the front on the ring 200 and is displayed a little larger than the icons 202 to 204 at the other positions.

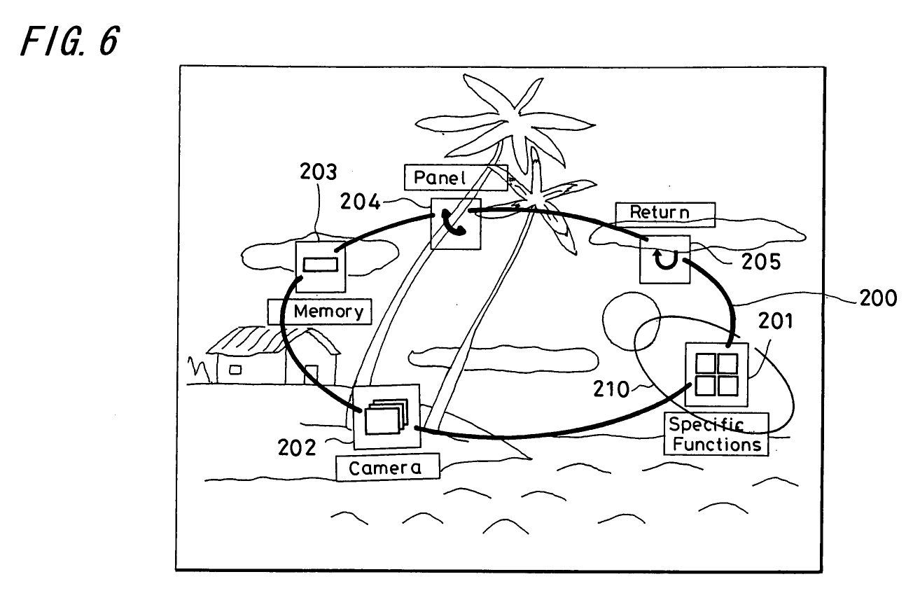

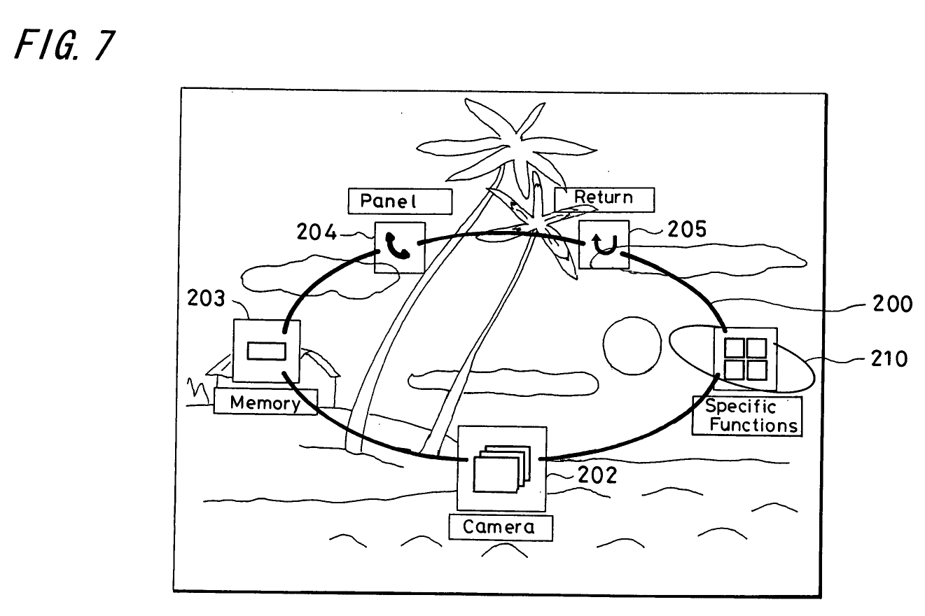

When there is an operation of an up-key or a down-key in the atate shown in FIG. 5, the display of ring rotates; a display changes sequentially as shown in FIGS. 6 and 7; and each displayed position of icons 201 to 205 is moving gradually. Here, with one step operation, the icon 202 next to the icon 201 comes to be displayed in the center of the front (condition shown in FIG. 7). As for the ring 210 of lower layer displayed in the surroundings of the icon 201 is moved as well concurrently with the icon 201. As shown in FIG. 7, under the condition in which the ring is rotated by one step, the icon 202 is displayed larger than the other icons, and the icon 201 which came off the center becomes small. Note that in the display examples of FIGS. 5 to 7, an icon displayed at the back of the ring 200 (for example, icons 203 and 204 in FIG. 5) is displayed further smaller, and icons are arranged to be seen as three dimensional. When the icon 205 indicating “return” is selected, processing of returning to the previous state, namely, the processing of ending a menu screen display is performed.

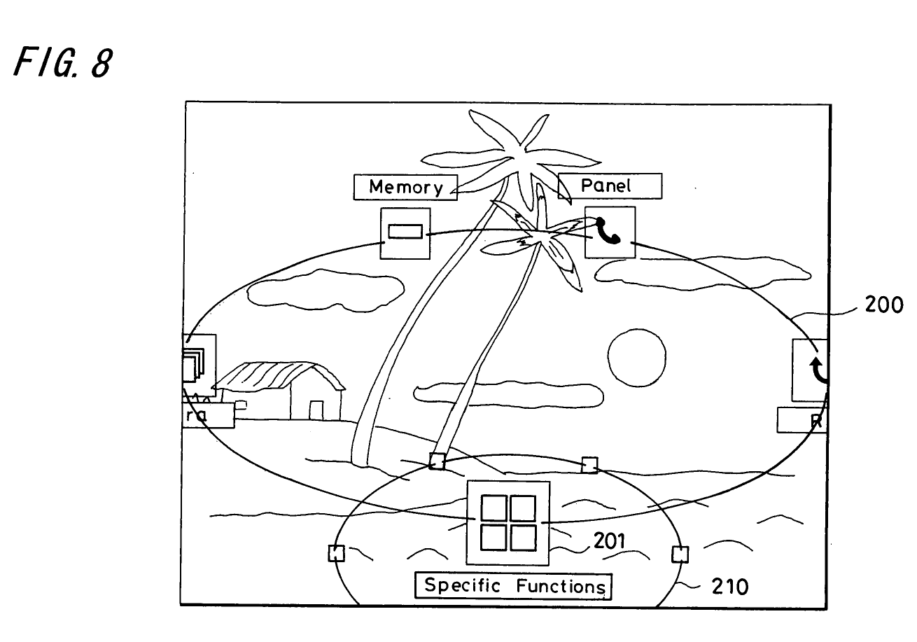

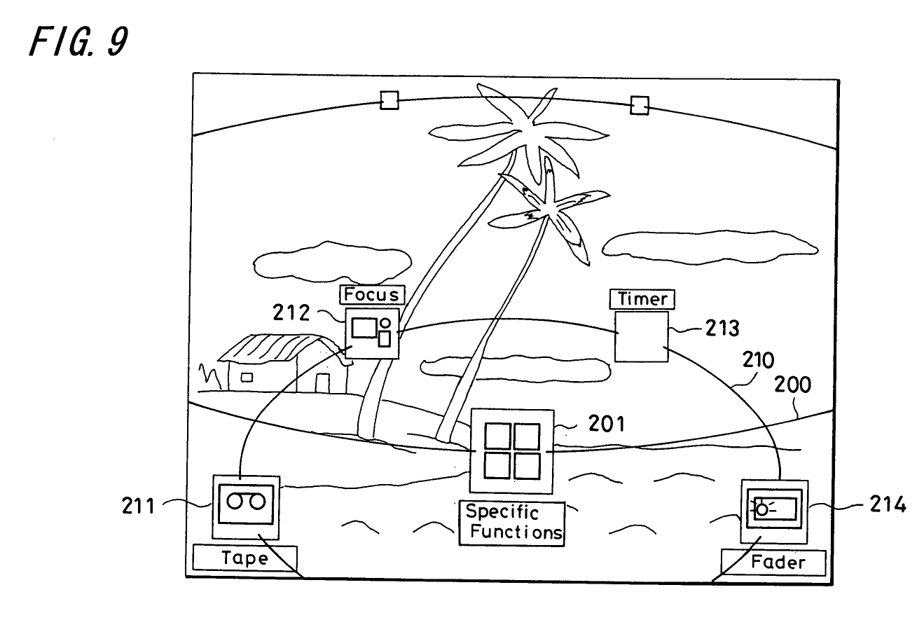

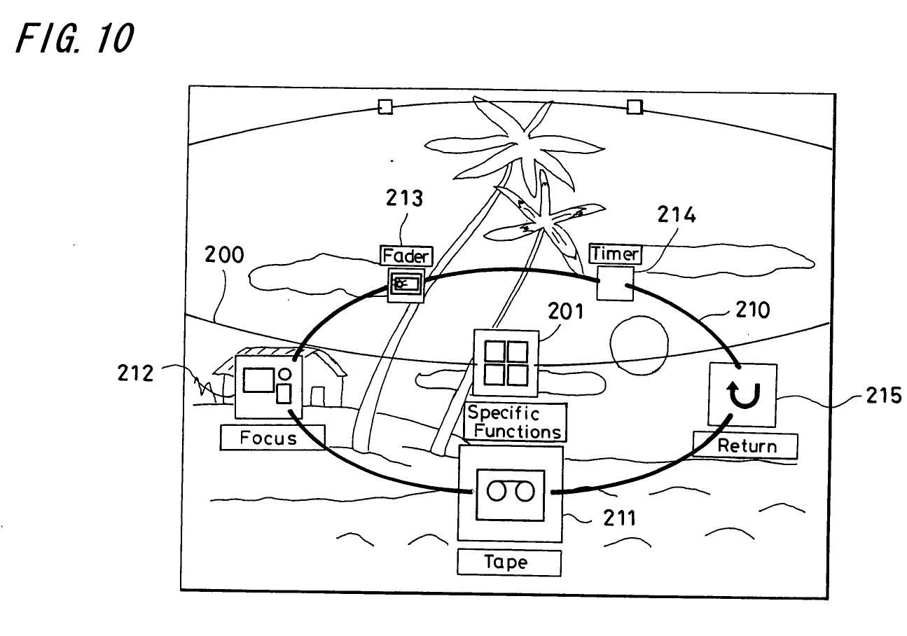

Further, when an icon having a ring of lower layer was selected, the ring of lower layer is changed to be displayed in larger scale. For example, as shown in FIG. 5, under the condition in which the icon 201 is displayed in the center, when an operation of selecting this icon 201 is performed, a display changes sequentially as shown in FIGS. 8 and 9, for example, and the icon 201 and ring 210 expand gradually; and when the ring 210 expands until the size that exactly fits into the screen, a position of display of the icon 201 moves toward the center in a picture screen as shown in FIG. 10, so that icons 211 to 215 arranged along the ring 210 are positioned in the state to be selected.

Under the condition shown in FIG. 10, the ring 210 is rotated and then the selection of each icon is confirmed, so that a display is changed to be capable of an operation shown with that icon being performed. When the icon 215 that is arranged on the ring 210 and shows the return is selected, the display returns to the previous layer, namely, returns to the state shown in FIG. 5.

As described above, by displaying rings of a hierarchical structure as a menu screen, a layered structure is easy to be understood from the display, and consequently, the operability of an operation in accordance with a menu screen is improved.

Further, in the above description, explanations are given to the examples in which a menu screen of a video camera is displayed; however, if electronic equipment is configured as a display apparatus having a display means capable of similar display, needless to say, the present invention can be applied to various electronic apparatuses other than the video camera. For example, the present invention can be applied to various small-sized portable electronic apparatuses such as a mobile phone unit, in which a display panel capable of displaying a menu screen is provided.

According to the present invention, since a plurality of icons are displayed along a ring, selection of a desired icon on a menu screen can be made easily only with the operation of rotating a ring and confirming the operation in the state of showing a certain display position.

In this case, since the icon displayed on a specific position on a ring is displayed larger than the other icons positioned on the ring, selection of the icon displayed on a specific position is easy to be understood by a display, and the operability of a menu screen is improved.

Further, when a plurality of input items exist with respect to an icon displayed on a ring, a sub-ring of a smaller diameter than the ring is displayed surrounding a position of displaying the icon; and when the icon having the displayed sub-ring is displayed on a specific position, if there is an operation of confirming a selected item, the sub-ring is enlarged to be displayed and on the sub-ring displayed in larger scale, icons corresponding to respective input items are displayed at predetermined intervals; so that display of icons with a hierarchical structure can be efficiently performed by the use of a plurality of rings.

Furthermore, since one of the icons displayed on a ring is an icon making a display return to the previous layer by one step, an operation to return to the previous layer can be made easily by the selection of that icon.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. A display method of displaying an input state of electronic equipment on a menu screen, wherein
a ring is displayed on a picture screen and a plurality of icons are displayed at predetermined intervals on the ring;
when there is an operation that selects an item on the menu screen, each of icons displayed on said ring is rotated on the ring with maintaining the order of arrangement; and
when there is an operation that confirms a selected item on the menu screen, an input operation with respect to an icon displayed at a specific position of said ring can be performed.

2. A display method according to claim 1, wherein
said icon displayed at a specific position of said ring is displayed larger than the other icons positioned on the ring.

3. A display method according to claim 1, wherein
when a plurality of input items exist with respect to an icon displayed on said ring, a sub-ring of smaller diameter than said ring is displayed surrounding a displayed position of the icon;
when the icon having said displayed sub-ring is displayed at said specific position and then there is an operation that confirms a selected item, said sub-ring is enlarged to be displayed; and
icons corresponding to respective input items are displayed at predetermined intervals on the sub-ring displayed in enlarged scale

4. A display method according to claim 1, wherein
one of the icons displayed on said ring is an icon that performs an operation of returning to the display of the previous layer by one.

5. A display device comprising:
an operation means for performing an input operation,
a display means for displaying a state set by said operation means,
a control means for, when there is an operation by said operation means that makes a menu screen display, making a ring to be displayed on a picture screen displayed by said display means; making a plurality of icons to be displayed at predetermined intervals on the ring; when there is an operation by said operation means that selects an item in a menu screen, rotating each of icons displayed on said ring with maintaining the order of arrangement; and when there is an operation by said operation means that confirms a selected item in a menu screen, receiving an input with respect to an icon displayed at a specific position of said ring.

6. A display device according to claim 5, wherein
said control means performs control of making an icon displayed at a specific position of the ring displayed by said display means display larger than the other icons positioned on the ring.

7. A display device according to claim 5, wherein
said control means performs controls of: when a plurality of input items exist with respect to a displayed icon on the a ring, making a sub-ring of smaller diameter than said ring to be displayed surrounding a displayed position of the icon; when the icon having the displayed sub-ring is displayed at said specific position and then there is an operation that confirms a selected item, making said sub-ring to be displayed in enlarged scale; and making icons corresponding to respective input items to be displayed at predetermined intervals on the sub-ring displayed in enlarged scale.

8. A display device according to claim 5, wherein
said control means makes an icon that performs an operation of returning to the display of the previous layer by one, to be displayed as one of icons displayed on said ring.
